(19) United States
(12) Patent Application Publication
(10) Pub. No.: US 2012/0213940 A1
(43) Pub. Date: Aug. 23, 2012

(54) ATOMIC LAYER DEPOSITION OF SILICON NITRIDE USING DUAL-SOURCE PRECURSOR AND INTERLEAVED PLASMA

(75) Inventor: Abhijit Basu Mallick, Palo Alto, CA (US)

(73) Assignee: Applied Materials, Inc., Santa Clara, CA (US)

(21) Appl. No.: 13/214,730

(22) Filed: Aug. 22, 2011

Related U.S. Application Data
(60) Provisional application No. 61/389,344, filed on Oct. 4, 2010.

(51) Int. Cl. B05D 3/04

(52) U.S. Cl. 427/535

(57) ABSTRACT

Atomic layer deposition using a precursor having both nitrogen and silicon components is described. The deposition precursor contains molecules which supply both nitrogen and silicon to a growing film of silicon nitride. Silicon-nitrogen bonds may be present in the precursor molecule, but hydrogen and/or halogens may also be present. The growth substrate may be terminated in a variety of ways and exposure to the deposition precursor displaces species from the outer layer of the growth substrate, replacing them with an atomic-scale silicon-and-nitrogen-containing layer. The silicon-and-nitrogen-containing layer grows until one complete layer is produced and then stops (self-limiting growth kinetics). Subsequent exposure to a plasma excited gas modifies the chemical termination of the surface so the growth step may be repeated. The presence of both silicon and nitrogen in the deposition precursor molecule increases the deposition per cycle thereby reducing the number of precursor exposures to grow a film of the same thickness.

### CROSS-REFERENCES TO RELATED APPLICATIONS

This application claims the benefit of U.S. Prov. Pat. App. No. 61/389,344 filed Oct. 4, 2010, and titled “ATOMIC LAYER DEPOSITION OF SILICON NITRIDE USING DUAL-SOURCE PRECURSOR AND INTERLEAVED PLASMA,” which is incorporated herein by reference in its entirety for all purposes.

### BACKGROUND OF THE INVENTION

Silicon nitride dielectric films are used as etch stops and chemically inert diffusion barriers. Other applications benefit from the relatively high dielectric constant, which allows electrical signals to be rapidly transmitted through a silicon nitride layer. There are two conventional methods for depositing a silicon nitride film: (1) plasma-enhanced chemical vapor deposition (PECVD) at substrate temperatures of more than 250° C.; and (2) low-pressure chemical vapor deposition (LPCVD) process at a substrate temperature generally greater than 750° C. While satisfactory for larger integrated circuit linewidths, these methods can cause diffusion at interfaces due to the high deposition temperature. Diffusion may degrade the integrity or inertness of silicon nitride films and may even degrade electrical characteristics of miniature electrical devices.

In addition to lower substrate temperatures, thin films used in semiconductor devices will increasingly require atomic layer control during deposition due to the decreasing linewidths. These thin films will also be required to have improved step coverage and conformality. To satisfy the requirements, atomic layer deposition (ALD) processes have gained traction in semiconductor manufacturing.

ALD silicon nitride films have been deposited at temperatures less than 500° C. via sequential exposure of a surface to halogenated silanes (such as Si₂Cl₄) and nitrogen sources (such as NH₃). In this exemplary prior art process, a Si₂Cl₄ source is provided in a substrate processing region containing a substrate having an exposed hydrogen-terminated surface. The Si₂Cl₄ source reacts with the hydrogens in this first deposition step, and —SiCl is adsorbed on the surface of the substrate while HCl by-products are formed and released in the reaction chamber. When the reaction of Si₂Cl₄ with the hydrogen terminated surface is essentially complete, a monolayer of Si has been added to the surface of the substrate. The silicon monolayer is terminated with chlorine and further exposure to Si₂Cl₄ results in insignificant additional deposition. This type of a reaction is referred to as self-limiting. At this point, the surface of the substrate is terminated with —SiCl surface chemical species.

An ammonia (NH₃) source is then flowed into the substrate processing region. Ammonia reacts with the —SiCl surface chemical species to adsorb an NH₂ terminated surface and HCl by-products. At this point, a monolayer of nitrogen has been added on top of the previously deposited monolayer of silicon. This second deposition step is also self-limiting; further exposure to H₂O results in little additional deposition. These two deposition steps may be repeated to deposit a silicon nitride film having a selectable thickness. Prior art deposition methods, such as this, are limited to substrate temperatures above 100° C. and relatively low precursor reaction rates.

Thus, there remains a need for new atomic layer deposition processes and materials to form relatively pure dielectric materials at low temperatures but increased growth rates. This and other needs are addressed in the present application.

### BRIEF SUMMARY OF THE INVENTION

Atomic layer deposition using a precursor having both nitrogen and silicon components is described. The deposition precursor contains molecules which supply both nitrogen and silicon to a growing film of silicon nitride. Silicon-nitrogen bonds may be present in the precursor molecule, but hydrogen and/or halogens may also be present. The growth substrate may be terminated in a variety of ways and exposure to the deposition precursor displaces species from the outer layer of the growth substrate, replacing them with an atomic-scale silicon-and-nitrogen-containing layer. The silicon-and-nitrogen-containing layer grows until one complete layer is produced and then stops (self-limiting growth kinetics). Subsequent exposure to a plasma excited gas modifies the chemical termination of the surface so the growth step may be repeated. The presence of both silicon and nitrogen in the deposition precursor molecule increases the deposition per cycle thereby reducing the number of precursor exposures to grow a film of the same thickness.

Embodiments of the invention include methods of forming a silicon nitride layer on a surface of a substrate within a substrate processing region. The surface has an initial chemical termination. The methods include the sequential steps of: (i) exciting a halogen-containing precursor in a plasma to form halogen-containing plasma effluents, and plasma-treating the surface by exposing an exposed surface of the substrate to the halogen-containing plasma effluents to halogen terminate the exposed surface, (ii) removing process effluents including unreacted halogen-containing plasma effluents from the substrate processing region, (iii) flowing a silicon-and-nitrogen-containing precursor comprising silicon-and-nitrogen-containing molecules into the substrate processing region to react with the plasma-treated surface to form a hydrogen-terminated atomic layer of silicon nitride, and (iv) removing process effluents including unreacted silicon-and-nitrogen-containing molecules from the substrate processing region. The methods further include repeating sequential steps (i)-(iv) until the silicon nitride layer reaches a target thickness.

Embodiments of the invention include methods of forming a silicon nitride layer on a surface of a substrate within a substrate processing region. The surface has an initial chemical termination. The methods include the sequential steps: (i) flowing a hydrogen-containing precursor into a plasma to form hydrogen-containing plasma effluents, and plasma-treating the surface by exposing an exposed surface of the substrate to the hydrogen-containing plasma effluents to hydrogen terminate the exposed surface, (ii) removing process effluents including unreacted hydrogen-containing plasma effluents from the substrate processing region, (iii) flowing a halogen-silicon-and-nitrogen-containing precursor comprising halogen-silicon-and-nitrogen-containing molecules into the substrate processing region to react with the plasma-treated surface to form a halogen-terminated atomic layer of silicon nitride, and (iv) removing process effluents including unreacted silicon-and-nitrogen-containing molecules from the substrate processing region. The methods further include repeating sequential steps (i)-(iv) until the silicon nitride layer reaches a target thickness.

Additional embodiments and features are set forth in part in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flowchart illustrating selected steps for forming silicon nitride dielectric layers according to disclosed embodiments.

FIG. 2 is a sequence of chemical schematic for atomic layer deposition according to disclosed embodiments.

FIG. 3 is a flowchart illustrating selected steps for forming silicon nitride dielectric layers according to disclosed embodiments.

### DETAILED DESCRIPTION OF THE INVENTION

Atomic layer deposition using a precursor having both nitrogen and silicon components is described. The deposition precursor contains molecules which supply both nitrogen and silicon to a growing film of silicon nitride. Silicon-nitrogen bonds may be present in the precursor molecule, but hydrogen and/or halogens may also be present. The growth substrate may be terminated in a variety of ways and exposure to the deposition precursor displaces species from the outer layer of the growth substrate, replacing them with an atomic-scale silicon-and-nitrogen-containing layer. The silicon-and-nitrogen-containing layer grows until one complete layer is produced and then stops (self-limiting growth kinetics). Subsequent exposure to a plasma excited gas modifies the chemical termination of the surface so the growth step may be repeated. The presence of both silicon and nitrogen in the deposition precursor molecule increases the deposition per cycle thereby reducing the number of precursor exposures to grow a film of the same thickness.

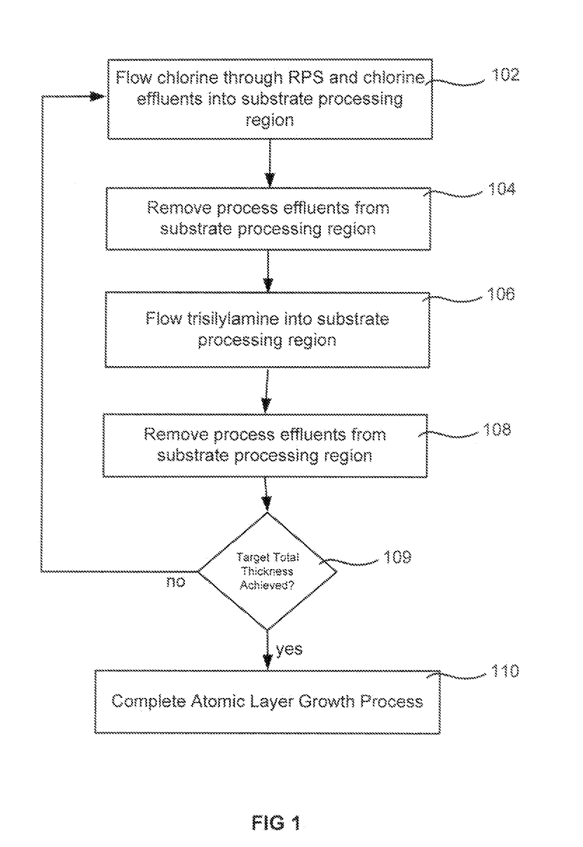

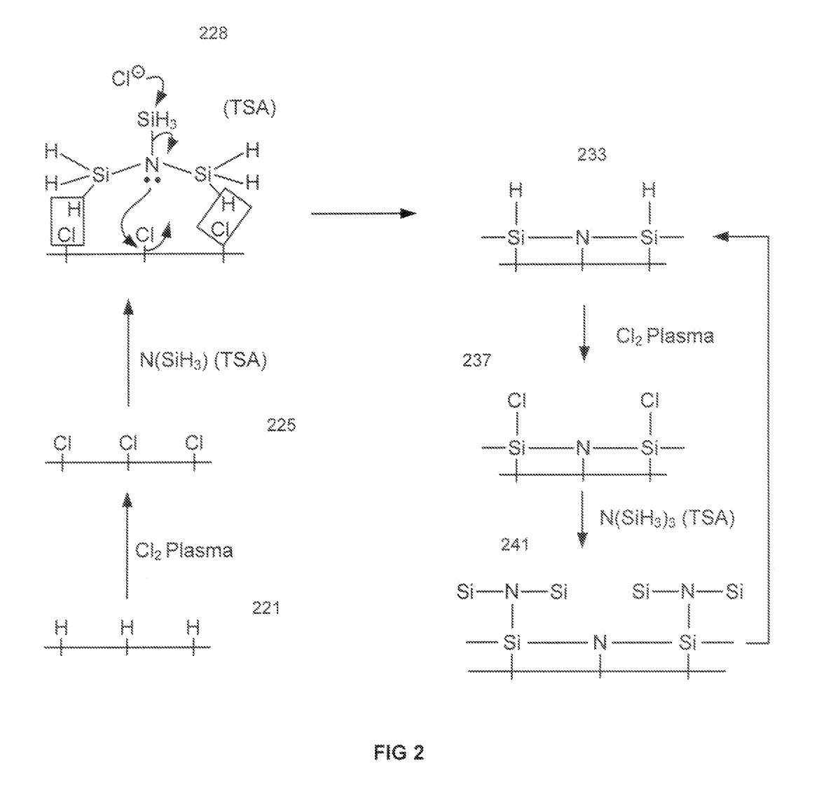

In order to better understand and appreciate the invention, reference is now made to FIGS. 1-2 which are a flowchart showing exemplary selected steps for performing atomic layer deposition and a sequence of chemical schematics during the deposition according to embodiments of the invention. The method includes a chlorine plasma treatment (step 102) to turn a hydrogen-terminated surface 221 into a chlorine-terminated surface 225. The chlorine plasma may be in a separate region from the substrate processing chamber and/or a partitioned compartment within the substrate processing chamber. The terms “remote plasma” and “remote plasma system” (i.e. RPS) will be used to describe these possibilities. The chlorine may be supplied by a variety of chlorine-containing precursors and the plasma may be formed by flowing, for example, molecular chlorine (Cl₂) into the plasma region(s). Chlorine-containing plasma effluents created in the RPS are then flowed into the substrate processing region to create the chlorine-terminated surface 225. Process effluents, including any unreacted chlorine-containing plasma effluents, may be removed from the substrate processing region (step 104). Generally speaking, a halogen-containing precursor may be used during step 102 in embodiments and halogen-containing plasma effluents then flow into the substrate processing region to create a halogen-terminated surface. Process effluents, including left-over unreacted halogen-containing plasma effluents are removed in step 104. The halogen-containing precursor may include one or more of Cl₂, Br₂ or F₂. Plasma-treating the surface with the halogen-containing plasma effluents halogen terminates the exposed surface.

The chlorine-terminated surface 225 may then have a silicon-and-nitrogen-containing layer formed on the surface by exposing chlorine-terminated surface 225 to a flow of trisilylamine (TSA or (SiH₃)₃N) in the substrate processing region (step 106). Hydrogen bound to the silicon atoms in the precursor may liberate the chlorines bound to the surface and the reaction produces HCl. The HCl may be removed from the processing region either during or after step 106 in embodiments. An additional surface-bound chlorine may be liberated in the form of a monochlorosilane (SiH₃Cl). The reaction of TSA with the chlorine-terminated surface is shown schematically 228 in FIG. 2. A portion of the growing silicon-and-nitrogen-containing layer is shown schematically 233 following the creation of the volatile species (SiH₃Cl and HCl) and the deposition of the atomic-scale layer of silicon nitride. A silicon-and-nitrogen-containing layer, grown to completion, is hydrogen terminated 233 which assists in the self-limiting nature of the reaction.

The flow of TSA is stopped and process effluents are removed from the substrate processing region (step 108). The process effluents include unreacted TSA as well as other process by-products which may remain in the gas phase following growth of the atomic-scale layer of silicon nitride. The newly exposed surface now has a post-deposition chemical termination which differs from the pre-deposition chemical termination. This difference results in the self-limiting growth kinetics of the atomic layer deposition technique. If the target thickness has been achieved (decision 109) the growth process is complete (step 110). Otherwise, another silicon-and-nitrogen-containing layer may be added by repeating the sequence of operations, beginning with step 102. The repeated exposure of the substrate to the chlorine-containing plasma effluents modifies the hydrogen-terminated layer 233 to create a chlorine-terminated layer 237. Chlorine termination of the new substrate allows the process to continue until the target thickness is achieved. Chemical schematic 241 shows a surface after formation of a second silicon-and-nitrogen-containing layer.

Alternatively, the initial surface of the substrate may be hydroxyl (—OH) terminated with hydroxyl groups and no chlorine plasma treatment is needed before exposing the substrate to TSA to grow the initial silicon-and-nitrogen-containing layer. The process may proceed as described in the remainder of the flowcharts and chemical schematics of FIGS. 1-2. In this scenario, a thin monolayer (or sub-monolayer) of oxygen remains at the bottom of the completed film. Chlorine is used, as before, between each exposure to TSA. The oxygen layer is tolerable and even beneficial in some applications, for example, the presence of oxygen may accommodate potential stress in the ALD film.

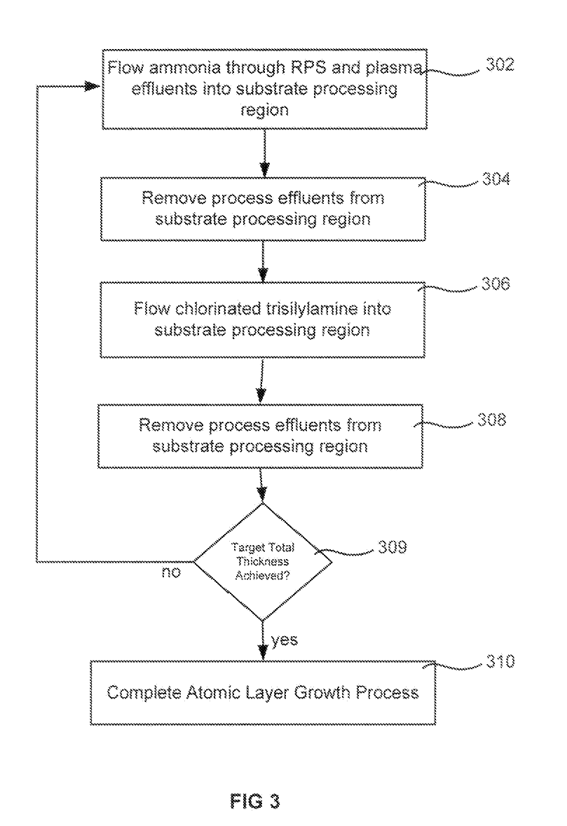

FIG. 3 is another flowchart showing selected steps for performing atomic layer deposition of silicon nitride representing additional embodiments of the invention. The method includes an ammonia plasma treatment (step 302) to turn a chlorine-terminated surface into a hydrogen-terminated surface. The ammonia plasma may be in a separate region from the substrate processing chamber and/or a partitioned compartment within the substrate processing chamber. The terms “remote plasma” and “remote plasma system” (i.e. RPS) will be used to describe these possibilities. The ammonia may be supplemented or replaced by a variety of hydrogen-containing precursors and the plasma may be formed by flowing, for example, molecular chlorine (H₂) into the plasma region(s). Hydrogen-containing plasma effluents created in the RPS are then flowed into the substrate processing region to create the hydrogen-terminated surface. Process effluents including any unreacted hydrogen-containing plasma effluents may be removed from the substrate processing region (step 304).

The hydrogen-terminated substrate may then have a silicon-and-nitrogen-containing layer formed on the surface by exposing the hydrogen-terminated substrate to a flow of perchlorinated trisilylamine (perchlorinated TSA or (SiCl₃)₃N) in the substrate processing region (step 306). Chlorine bound to the silicon atoms within the precursor may liberate the hydrogens bound to the surface and the reaction produces HCl. The HCl may be removed from the processing region either during or after step 306 in embodiments. An additional surface-bound hydrogen may be liberated in the form of a trichlorosilane (SiHCl₃). The steps for performing atomic layer deposition of silicon nitride are analogous to the chemical schematics of FIG. 2, but with all the chlorine atoms of FIG. 2 replaced with hydrogen atoms and all the hydrogen atoms of FIG. 2 replaced with chlorine atoms. A silicon-and-nitrogen-containing atomic-scale layer, grown to completion, is chlorine terminated which assists in the self-limiting nature of the reaction.

The flow of perchlorinated TSA is stopped and process effluents are removed from the substrate processing region (step 308). The process effluents may include unreacted chlorine TSA as well as any other process by-products which remain in the gas phase following growth of the atomic-scale layer of silicon nitride. The newly exposed surface now has a post-deposition chemical termination which differs from the pre-deposition chemical termination. This difference results in the self-limiting growth kinetics of the atomic layer deposition technique. If the target thickness has been achieved (decision 309) the growth process is complete (step 310). Otherwise, another silicon-and-nitrogen-containing layer may be added by repeating the sequence of operations, beginning with step 302. The repeated exposure of the substrate to the hydrogen-containing plasma effluents modifies the chlorine-terminated layer to create a hydrogen-terminated layer. Hydrogen termination of the new substrate allows the process to continue until the target thickness is achieved.

Generally speaking, a halogen-silicon-and-nitrogen-containing precursor may be used during step 306 and may include one or more of Cl, Br or F atoms substituted in some or all the locations where hydrogen would normally bond. A perchlorinated silylamine may be used for the halogen-silicon-and-nitrogen-containing precursor and represents a silylamine having chlorine substituted at each site usually terminated with a hydrogen. Perbromated silylamines and perfluorinated silylamines may also be used in embodiments of the invention. Perhalogenated silylamine may be used herein to describe any of the above halogen-substituted silylamines. These variations are possible with any of the silylamines listed herein (e.g. MSA, DSA and TSA).

The inventors have found that plasma treatments other than chlorine allow atomic layer deposition to proceed layer-by-layer. Other halogens, such as fluorine and bromine, may be flowed into a RPS and/or an in-situ substrate processing region plasma. Halogen-containing plasma effluents are then used to displace the hydrogen termination and halogen-terminate the substrate surface (for process flows like FIG. 1) and form a halogen termination. The inventors have also determined that an ammonia plasma treats the surface and enables another silicon-and-nitrogen-containing layer to be deposited by ALD (for process flows like FIG. 3). Generally speaking, stable species may be flowed into a plasma to prepare the surface for an additional ALD cycle by exposing the surface to the plasma effluents. These stable species may include one or more of HCl, F₂, Br₂, Cl₂, NH₃ and N₂H₄ (hydrazine). Hydrogen (H₂) and nitrogen (N₂) may be combined to form another stable species for delivery into the plasma and either may be added to the previous stable precursors and flowed into the plasma. The stable precursor may comprise hydrogen but be essentially devoid of halogens or the stable precursor may comprise halogen but be essentially devoid of hydrogen in different embodiments. The pre-deposition chemical terminations may include one of bromine, chlorine, fluorine, hydrogen and/or nitrogen.

Regarding the growth cycle, other silylamines may be used to grow the silicon-and-nitrogen-containing layer. The growth precursor may include monosilylamine (MSA), disilylamine (DSA) and/or trisilylamine (TSA) in embodiments relating to the process flow of FIG. 1. The halogenated counterpart (using either F, Br or Cl) may be used for the growth precursor in embodiments relating to the process flow of FIG. 3. Generally speaking, the growth precursor is a silicon-and-nitrogen-containing molecule, in embodiments of the invention. The growth precursor may contain at least one Si—N bond. Essentially no plasma is used to excite the silylamine, in embodiments, so the deposition is limited to self-limiting growth of a single silicon-and-nitrogen-containing layer.

The presence of both silicon and nitrogen in the growth precursor (the silylamine) may result in a greater thickness than single-source precursors. As a reminder, examples of single-source precursors include alternating exposures of Si₂Cl₄ and NH₃. Using dual-source precursors, a cycle of atomic layer deposition (steps 102-108 or steps 302-308) deposits more than 1 Å, less than 6 Å or between 1 Å and 6 Å of silicon nitride on the substrate in disclosed embodiments. The duration of flowing the growth precursor into the substrate processing region is less than two seconds, in embodiments of the invention. The duration may also include the operation of plasma treating the surface in preparation for the next deposition cycle in an embodiment. The pressure within the substrate processing region is below 10 mTorr during one or both of the steps of flowing the silylamine precursor and flowing the plasma effluents in disclosed embodiments. The substrate temperature may be less than 100° C. during the deposition process. The substrate may be a patterned substrate having a trench with a width of about 25 nm or less.

Halogen (e.g. —Cl) and hydroxyl (—OH) terminations are examples of pre-deposition terminations and a hydrogen (—H) terminated surface is an example of a post-deposition chemical termination according to embodiments of the invention. The pre and post-deposition chemical terminations are different, in embodiments of the invention, which means some of the elemental constituents residing on the exposed surfaces differ between the two chemical terminations. The pre-deposition chemical termination may be hydrogen terminated if halogenated silylamines become commercially available. A perchlorinated silylamine would deposit a silicon-and-nitrogen-containing layer with chlorine termination, in embodiments of the invention. In such a scenario, a hydrogen-containing plasma would be used to hydrogen terminate the surface and allow further exposure to the perchlorinated silylamine to deposit another layer. Growth precursors may be partially halogenated silylamines or perhalogenated silylamines, in embodiments of the invention.

As used herein “substrate” may be a support substrate with or without layers formed thereon. The support substrate may be an insulator or a semiconductor of a variety of doping concentrations and profiles and may, for example, be a semiconductor substrate of the type used in the manufacture of integrated circuits. A layer of “silicon nitride” is used as a shorthand for and interchangeably with a silicon-and-nitrogen-containing material. As such, silicon nitride may include concentrations of other elemental constituents such as oxygen, hydrogen, carbon and the like. In some embodiments, silicon nitride consists essentially of silicon and nitrogen. The term “precursor” is used to refer to any process gas which takes part in a reaction to either remove material from or deposit material onto a surface. Plasma effluents describe a gas in an “excited state”, wherein at least some of the gas molecules are in vibrationally-excited, dissociated and/or ionized states. A “gas” (or a “precursor”) may be a combination of two or more gases (or “precursors”) and may include substances which are normally liquid or solid but temporarily carried along with other “carrier gases.” The phrase “inert gas” refers to any gas which does not form chemical bonds when etching or being incorporated into a film. Exemplary inert gases include noble gases but may include other gases so long as no chemical bonds are formed when (typically) trace amounts are trapped in a film.

The term “trench” is used throughout with no implication that the etched geometry has a large horizontal aspect ratio. Viewed from above the surface, trenches may appear circular, oval, polygonal, rectangular, or a variety of other shapes. The term “via” is used to refer to a low aspect ratio trench (as viewed from above) which may or may not be filled with metal to form a vertical electrical connection. As used herein, a conformal layer refers to a generally uniform layer of material on a surface in the same shape as the surface, i.e., the surface of the layer and the surface being covered are generally parallel. A person having ordinary skill in the art will recognize that the deposited material likely cannot be 100% conformal and thus the term “generally” allows for acceptable tolerances.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the precursor” includes reference to one or more precursor and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of forming a silicon nitride layer on a surface of a substrate within a substrate processing region, wherein the surface has an initial chemical termination, the method comprising the sequential steps of:
(i) exciting a halogen-containing precursor in a plasma to form halogen-containing plasma effluents, and plasma-treating the surface by exposing an exposed surface of the substrate to the halogen-containing plasma effluents to halogen terminate the exposed surface to form a halogen termination,
(ii) removing process effluents from the substrate processing region,
(iii) flowing a silicon-and-nitrogen-containing precursor comprising silicon-and-nitrogen-containing molecules into the substrate processing region to react with the plasma-treated surface to form a hydrogen-terminated atomic layer of silicon nitride, and
(iv) removing process effluents from the substrate processing region; and
repeating sequential steps (i)-(iv) until the silicon nitride layer reaches a target thickness.

2. The method of claims 1, wherein the silicon-and-nitrogen-containing molecules comprises a Si—N bond.

3. The method of claim 1, wherein the silicon-and-nitrogen-containing molecules are silylamines.

4. The method of claim 1, wherein the silicon-and-nitrogen-containing molecules contain no halogens.

5. The method of claim 1, wherein the silicon-and-nitrogen-containing molecules comprise one of trisilylamine, disilylamine or monosilylamine.

6. The method of claim 1, wherein the operation of plasma-treating the surface displaces hydrogen and terminates the exposed surface with one of fluorine, bromine or chlorine.

7. The method of claim 1, wherein the halogen-containing plasma effluents are formed outside the substrate processing region.

8. The method of claim 1, wherein the halogen-containing plasma effluents are formed inside the substrate processing region.

9. The method of claim 1, wherein the initial chemical termination comprises hydroxyl groups.

10. The method of claim 1, wherein a pressure within the substrate processing region is below 10 mTorr during flowing the silicon-and-nitrogen-containing precursor.

11. The method of claim 1, wherein a pressure within the substrate processing region is below 10 mTorr during plasma-treating the surface.

12. The method of claim 1, wherein the substrate is a patterned substrate having a trench with a width of about 25 nm or less.

13. The method of claim 1, wherein the operation of flowing the silicon-and-nitrogen-containing precursor into the substrate processing region lasts for two seconds or less.

14. The method of claim 1, wherein each combination of the sequential steps (i)-(iv) comprises depositing between 1 Å and 6 Å of additional silicon nitride on the substrate.

15. A method of forming a silicon nitride layer on a surface of a substrate within a substrate processing region, wherein the surface has an initial chemical termination, the method comprising the sequential steps of:
(i) flowing a hydrogen-containing precursor into a plasma to form hydrogen-containing plasma effluents, and plasma-treating the surface by exposing an exposed surface of the substrate to the hydrogen-containing plasma effluents to hydrogen terminate the exposed surface,
(ii) removing process effluents from the substrate processing region,
(iii) flowing a halogen-silicon-and-nitrogen-containing precursor comprising halogen-silicon-and-nitrogen-containing molecules into the substrate processing region to react with the plasma-treated surface to form a halogen-terminated atomic layer of silicon nitride, and
(iv) removing process effluents from the substrate processing region; and
repeating sequential steps (i)-(iv) until the silicon nitride layer reaches a target thickness.

16. The method of claims 15, wherein the halogen-silicon-and-nitrogen-containing molecules comprises a Si—N bond.

17. The method of claim 15, wherein the halogen-silicon-and-nitrogen-containing molecules comprises a perhalogenated silylamine.

18. The method of claim 15, the hydrogen-containing plasma effluents are formed outside the substrate processing region or inside the substrate processing region.

19. The method of claim 15, wherein the hydrogen-containing precursor comprises ammonia.

20. The method of claim 15, wherein each combination of the sequential steps (i)-(iv) comprises depositing between 1 Å and 6 Å of additional silicon nitride on the substrate.
